(19) United States
(12) Patent Application Publication
(10) Pub. No.: US 2025/0311730 A1
(43) Pub. Date: Oct. 9, 2025

(54) PEST CONTROL COMPOSITIONS

(71) Applicants: Dow Global Technologies LLC, Midland, MI (US); Rohm and Haas Company, Collegeville, PA (US)

(72) Inventors: Caroline Woelfle-Gupta, Midland, MI (US); Selvanathan Arumugam, West Chester, PA (US); Susan L. Jordan, Doylestown, PA (US); Yujing Tan, Midland, MI (US)

(21) Appl. No.: 18/863,122

(22) PCT Filed: May 31, 2022
(86) PCT No.: PCT/US2022/031536

§ 371 Date: Nov. 5, 2024

(51) Int. Cl. A01N 63/23; A01N 25/04; A01N 65/00; A01P 7/04

(52) U.S. Cl. CPC A01N 63/23; A01N 25/04; A01N 65/00; A01P 7/04

(57) ABSTRACT

A pest control composition includes humic acid and an emulsion polymer. The emulsion polymer includes including methyl methacrylate, butyl acrylate, acrylic acid and vinyl toluene. The pest control composition also includes bacillus thuringiensis and water.

### FIELD OF DISCLOSURE

The present disclosure is generally related to pest control compositions, and more specifically to pest control compositions comprising bacillus thuringiensis.

### BACKGROUND

Pest control agents are utilized to control pests, such as insects. The effectiveness of pest control agents can be influenced by a number of factors. There is continued focus in the industry on developing new and improved pest control compositions.

### SUMMARY

According to a first feature of the present disclosure, a pest control composition includes humic acid, an emulsion polymer including methyl methacrylate, butyl acrylate, acrylic acid and vinyl toluene; bacillus thuringiensis and water. According to a second feature of the present disclosure, the humic acid is from 0.01 wt % to 5.00 wt % of the pest control composition based upon a total weight of a combination of the humic acid, the emulsion polymer, the bacillus thuringiensis, and the water. According to a third feature of the present disclosure, the emulsion polymer is from 0.10 wt % to 10.00 wt % of the pest control composition based upon a total weight of the combination of the humic acid, the emulsion polymer, the bacillus thuringiensis, and the water. According to a fourth feature of the present disclosure, the emulsion polymer 10 wt % or less acrylic acid based on the weight of the emulsion polymer. According to a fifth feature of the present disclosure, wherein the emulsion polymer has an average particle diameter from 50 nanometers to 300 nanometers as measured using Dynamic Light Scattering.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated. Subscript values in polymer formulae refer to mole average values for the designated component in the polymer.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, a “wt %” or “weight percent” or “percent by weight” of a component, unless specifically stated to the contrary, is based on the total weight of the composition or article in which the component is included. As used herein, all percentages are by weight unless indicated otherwise.

Pest control compositions are disclosed herein. Embodiments of the present disclosure provide that the pest control compositions include humic acid, an emulsion polymer, bacillus thuringiensis, and water.

The pest control compositions disclosed herein may be applied to plants, e.g., plant surfaces, to control pests. Advantageously, the pest control compositions disclosed herein can provide improved, i.e., greater, bacillus thuringiensis activity following exposure to light, e.g., sunlight, as compared to other formulations. The improved bacillus thuringiensis activity indicates that the pest control compositions disclosed herein can provide greater pest control, as compared to other formulations having a relatively lesser bacillus thuringiensis activity following exposure to light. Surprisingly, components of the pest control compositions disclosed herein, i.e., the humic acid, the emulsion polymer, and the bacillus thuringiensis, show and unexpected synergy for improving bacillus thuringiensis activity following exposure to light.

The pest control compositions disclosed herein include humic acid. Humic acid is an acidic organic polymer that can be extracted from humus found in soil, sediment, or aquatic environments. Humic acid is identified by the Chemical Abstracts Service (CAS) number 1415-93-6 and has an average chemical formula C₁₈₇H₁₈₆O₈₉N₉S₁. Examples of commercially available humic acid include, but are not limited to, products available from Sigma-Aldrich, or Fisher Scientific.

One or more embodiments of the present disclosure provide that the humic acid may be a solid, e.g., that is incorporated into the pest control compositions disclosed herein. One or more embodiments of the present disclosure provide that the humic acid may be a mixture, e.g., a mixture of humic acid and a liquid such as water, that is incorporated into the pest control compositions disclosed herein. One or more embodiments of the present disclosure provide that the humic acid may be a solution, e.g., a solution of humic acid in a liquid such as water that is incorporated into the pest control compositions disclosed herein. Combinations of solids, mixtures, and solutions may be utilized. The humic acid may have various pH values for various applications.

The pest control compositions disclosed herein include an emulsion polymer. As used herein a “polymer” has two or more of the same or different monomeric structural units derived a number of monomers, e.g., homopolymers, copolymers, terpolymers, etc. “Monomeric structural unit”, as used herein in reference to polymers, indicates a portion of a polymer structure that results from the reaction of a monomer or monomers to form the polymer. “Different” in reference to monomeric structural units indicates that the monomeric polymer structural units differ from each other by at least one atom or are different isomerically.

The emulsion polymer can be prepared by emulsion polymerization, e.g., using known equipment, reaction components, and reaction conditions. The emulsion polymer may be a component of a stable dispersion of polymer particles in water, which may be referred to as a latex and/or an emulsion. Suitable latexes include stable aqueous dispersions of acrylic, styrene-acrylic, vinyl ester-acrylic, alkyd, and vinyl ester-polyethylene latexes.

One or more embodiments provide that the emulsion polymer is an acrylic based emulsion polymer. As used herein, “acrylic based emulsion polymer” refers to polymers having 20 wt % or more of monomeric structural units derived from an acrylic monomer, based upon a total weight of the polymer. As used herein “acrylic” refers to ethylenically unsaturated carboxylic acids or ethylenically unsaturated carboxylic acid derivatives, including esters, amides, and such. “Acrylic” includes methacrylic.

As mentioned, the emulsion polymer can include monomeric structural units derived from an acrylic monomer, e.g., an acrylic acid monomer. Examples of acrylic monomers include, but are not limited to, butyl methacrylate, butyl acrylate, methyl methacrylate, ethyl acrylate, methyl acrylate, 2-ethylehexyl acrylate, docosyl methacrylate, itaconic acid, fumaric acid, maleic anhydride crotonic acid, acrylic acid, methacrylic acid, maleic acid, acryloxypropionic acid, itaconic acid, fumaric acid, crotonic acid, acrylic acid, methacrylic acid, maleic acid, acryloxypropionic acid, citraconic acid, and combinations thereof. In one embodiment, a mono-ethylenically unsaturated carboxylic acid monomer may be utilized. The emulsion polymer can comprise 10 wt % or less of acrylic acid based on a total weight of the emulsion polymer.

One or more embodiments of the present disclosure provide that the emulsion polymer may contain monomeric structural units derived from an additional monomer. Examples of the additional monomer include, but are not limited to, styrene, ethylene, diisobutylene, vinyl acetate, vinyl toluene, and combinations thereof.

One or more embodiments of the present disclosure provide that the emulsion polymer can include from 0.1 wt % to 5 wt % of monomeric structural units derived from an adhesion promoting monomer. An example of the adhesion promoting monomer is ureido methacrylate, among others.

One or more embodiments of the present disclosure provide that the emulsion polymer can include from 0.1 wt % to 5 wt % of monomeric structural units derived from a cross linking monomer. An example of the crosslinking monomer is ally methacrylate, among others.

The emulsion polymer can include from 20 wt % to 100 wt % of monomeric structural units derived from the acrylic monomer, based upon a total weight of the emulsion polymer. All individual values and subranges from 20 wt % to 100 wt % are included; for example, the monomeric structural units derived from the acrylic monomer can be from a lower limit of 20 wt %, 25 wt %, 28 wt %, 30 wt %, 32 wt %, 35 wt %, or 40 wt % to an upper limit of 100 wt %, 95 wt %, 90 wt %, 85 wt %, 80 wt %, 75 wt %, 70 wt %, or 65 wt % based upon the total weight of the emulsion polymer.

Embodiments of the present disclosure provide that the emulsion polymer may contain monomeric structural units derived from the additional monomer, i.e. when less than 100 wt % of the monomeric structural units are derived the acrylic monomer. The emulsion polymer may contain from 1 wt % to 80 wt % of monomeric structural units derived from the additional monomer, based upon a total weight of the emulsion polymer. All individual values and subranges from 1 wt % to 80 wt % are included; for example, the emulsion polymer can have from a lower limit of 1 wt %, 3 wt %, 5 wt %, 10 wt %, or 20 wt % to an upper limit of 80 wt %, 75 wt %, 70 wt %, 68 wt %, or 65 wt % of monomeric structural units derived from the additional monomer, based upon the total weight of the emulsion polymer.

Embodiments of the present disclosure provide that the emulsion polymer may contain monomeric structural units derived from the adhesion promoting monomer, i.e. when less than 100 wt % of the monomeric structural units are derived the acrylic monomer. The emulsion polymer may contain from 0.1 wt % to 5.0 wt % of monomeric structural units derived from the adhesion promoting monomer, based upon a total weight of the emulsion polymer. All individual values and subranges from 0.1 to 5.0 wt % are included; for example, emulsion polymer can have from a lower limit of 0.1 wt %, 0.2 wt %, or 0.3 wt % to an upper limit of 5.0 wt %, 4.0 wt %, 3.0 wt % of monomeric structural units derived from the adhesion promoting monomer, based upon the total weight of the emulsion polymer.

Embodiments of the present disclosure provide that the emulsion polymer may contain monomeric structural units derived from the cross-linking monomer, i.e. when less than 100 wt % of the monomeric structural units are derived the acrylic monomer. The emulsion polymer may contain from 0.1 wt % to 5.0 wt % of monomeric structural units derived from the cross-linking monomer, based upon a total weight of the emulsion polymer. All individual values and subranges from 0.1 wt % to 5.0 wt % are included; for example, emulsion polymer can have from a lower limit of 0.1 wt %, 0.2 wt %, or 0.3 wt % to an upper limit of 5.0 wt %, 4.0 wt %, 3.0 wt % of monomeric structural units derived from the cross linking monomer, based upon the total weight of the emulsion polymer.

Embodiments of the present disclosure provide that the emulsion polymer has a weight average molecular weight (M_{w}) from 10,000 daltons to 3,000,000 daltons. All individual values and subranges from 10,000 daltons to 3,000,000 daltons are included; for example, the acrylic polymer may have a M_{w} from a lower limit of 10,000 daltons, 25,000 daltons, or 50,000 daltons to an upper limit of 3,000,000 daltons, 2,500,000 daltons, or 2,000,000 daltons. The weight average molecular weight of the emulsion polymer is determined using gel permeation chromatography.

Embodiments of the present disclosure provide that the emulsion polymer has an average particle diameter from 30 nanometers to 10 microns wherein emulsion polymer has an average particle diameter from 30 nanometers to 10 microns as measured using Dynamic Light Scattering. All individual values and subranges from 30 nanometers to 10 microns are included; for example, the emulsion polymer may have an average particle diameter from a lower limit of 30, 40, or 50 nanometers to an upper limit 10, 5, or 2 microns or 300 nanometers. Particle diameters herein are those measured by Dynamic Light Scattering on a BROOKHAVEN™ BI-90 Plus particle size analyzer.

As mentioned, the emulsion polymer may be a component of an emulsion. The emulsion may be obtained commercially or prepared by a known process, e.g. by conventional emulsion polymerization.

Embodiments of the present disclosure provide that the emulsion can have a solids content from 30 wt % to 60 wt %, based upon a total weight of the emulsion. All individual values and subranges from 30 wt % to 60 wt % are included; for example, the emulsion can have a solids content from a lower limit of 30 wt %, 32 wt %, or 35 wt % to an upper limit of 60 wt %, 55 wt %, or 45 wt % based upon the total weight of the emulsion. One or more embodiments provide that the emulsion is an aqueous emulsion.

The pest control compositions disclosed herein comprises bacillus thuringiensis. As defined herein, “bacillus thuringiensis” is the spores and/or the crystallized proteins of the species bacillus thuringiensis and includes all bacillus thuringiensis subspecies exhibiting insecticidal properties. Examples of such subspecies include kurstaki, israelensis and aizawa. The bacillus thuringiensis may be added to the pesticide formulation as either a solid or as part of a liquid formulation. The presence and subspecies of bacillus thuringiensis is determined by Random Amplified Polymorphic DNA analysis. A commercially available liquid formulation of bacillus thuringiensis is THURICIDE™ pesticide available from CERTIS USA, Columbia, Maryland. Bacillus thuringiensis can produce insecticidal crystal proteins, e.g., Cry proteins and Cyt proteins, by sporulation. Greater activity, following exposure to light, can provide desirably improved pest control.

One or more embodiments of the present disclosure provide that the pest control compositions disclosed herein can include an additive. Examples of additives include viscosity modifiers, pH modifiers, herbicides, fungicides, and combinations thereof, among others. Different amount of the additive may be utilized for various applications.

The pest control compositions disclosed herein can include from 0.01 wt % to 5.00 wt % of the humic acid, based upon a total weight of a combination of the humic acid, the emulsion polymer, the bacillus thuringiensis, and the water. All individual values and subranges from 0.01 wt % to 5.00 wt % are included; for example, the pest control composition can include the humic acid from a lower limit of 0.01 wt %, 0.05 wt %, 0.10 wt %, or 0.15 wt % to an upper limit of 5.00 wt %, 4.00 wt %, 3.50 wt %, or 3.00 wt % based upon the total weight of the combination of the humic acid, the emulsion polymer, the bacillus thuringiensis, and the water.

The pest control compositions disclosed herein can include from 0.10 wt % to 10.00 wt % of the emulsion polymer, based upon a total weight of a combination of the humic acid, emulsion polymer, the bacillus thuringiensis, and the water. All individual values and subranges from 0.10 wt % to 10.00 wt % are included; for example, the pest control composition can include the emulsion polymer from a lower limit of 0.10 wt %, 0.30 wt %, or 0.50 wt % to an upper limit of 10.00 wt %, 9.00 wt %, or 8.00 wt % based upon the total weight of the combination of the humic acid, the emulsion polymer, the bacillus thuringiensis, and the water.

The pest control compositions disclosed herein can include from 0.01 wt % to 20.00 wt % of the bacillus thuringiensis, based upon a total weight of a combination of the humic acid, the emulsion polymer, the bacillus thuringiensis, and the water. All individual values and subranges from 0.01 wt % to 20.00 wt % are included; for example, the pest control composition can include the bacillus thuringiensis from a lower limit of 0.01 wt %, 0.03 wt %, 0.04 wt %, or 0.05 wt % to an upper limit of 20.00 wt %, 15.00 wt %, 10.00 wt %, or 5.00 wt % based upon the total weight of the combination of the humic acid, the emulsion polymer, the bacillus thuringiensis, and the water.

The pest control compositions disclosed herein can include from 65.00 wt % to 99.88 wt % of water, based upon a total weight of a combination of the humic acid, the emulsion polymer, the bacillus thuringiensis, and the water. All individual values and subranges from 65.00 wt % to 99.88 wt % are included; for example, the pest control composition can include the water from a lower limit of 65.00 wt %, 66.00 wt %, or 68.00 wt % to an upper limit of 99.88 wt %, 99.00 wt %, or 98.00 wt % based upon the total weight of the combination of the humic acid, the emulsion polymer, the bacillus thuringiensis, and the water.

The pest control compositions disclosed herein can be formed using known equipment and processes. The components of the pest control compositions may be combined, e.g., mixed, to form the pest control compositions. For instance, the components of the pest control compositions may be added to a vessel and be agitated therein. The components of the pest control compositions may be combined in any order.

The pest control compositions disclosed herein may be applied to plants, e.g., plant surfaces, to control pests. The pest control compositions may be applied to plants using known equipment and processes. For instance, the pest control compositions may be sprayed, sprinkled, and/or poured, among other applications, to plants. Different amounts of the pest control composition may be applied to plants for various applications.

### EXAMPLES

In the Examples, various terms and designations for materials are used including, for instance, the following:

Emulsion-1 (emulsion containing an emulsion polymer, the emulsion polymer included: monomeric structural unit derived from: methyl methacrylate (40.9 wt %), butyl acrylate (54.9 wt %), adhesion promotor (1.0 wt %), vinyl toluene (1.9 wt %), and acrylic acid (1.3 wt %)); THURICIDE™ (liquid formulation, bacillus thuringiensis, obtained from Certis); humic acid-1 (humic acid, solid, pH 9.3, as determined with 2.5 wt % humic acid-1 solution); humic acid-2 (solid humic acid obtained from SIGMA-ALDRICH™); polyethylene oxide functionalized lignin.

Example 1, a pest control composition, was formed as follows. Emulsion-1 was diluted with deionized water to provide a solution (5 wt % of emulsion polymer in water). The solution (1 mL), THURICIDE™ (9.38 mL), and humic acid-1 (0.26 mL) were added to a container and mixed with a magnetic stir bar to provide Example 1.

Example 2, a pest control composition, was formed as Example 1 with the change that humic acid-2 (0.26 mL) was utilized rather than the humic acid-1.

Comparative Example A was formed as Example 1 with the change that Emulsion-1 was not utilized.

Comparative Example B was formed as Example 1 with the changes that humic acid-2 (0.26 mL) was utilized rather than the humic acid-1 and Emulsion-1 was not utilized.

Comparative Example C was formed as Example 1 with the change that polyethylene oxide functionalized lignin was utilized rather than the emulsion-1.

Comparative Example D was formed as Example 1 with the change that polyethylene oxide functionalized lignin was utilized in conjunction with the emulsion-1.

Bacillus thuringiensis activities before and after exposure to light for Examples 1-2 and Comparative Examples A-D were determined as follows.

An auto-pipettor was used to place respective 30 μL drops of Examples 1-2 and Comparative Examples A-D on a plastic petri dish; the drops were dried for approximately 1 hour.

For the samples exposed to light, the dried drops were exposed to light at 35 milliwatts/cm² for 2 hours.

The samples not exposed to light and the samples exposed to light were extracted and plated. For extraction, each of the samples was placed in 1 wt % solution of TWEEN™ 20 solution and incubated for approximately 12 hours. For plating, the samples were diluted to a desired starting concentration, using a 0.1 wt % solution of TWEEN™ 20 then then serially diluted at suitable concentrations and plated evenly in 10 μL drops. The plates were then held in an incubator at 30° C. for approximately 12 hours. Thereafter, the number of colonies were counted and expressed as log colony forming units/mL, while accounting for dilution factors. The results are reported in Tables 1-3.

TABLE 1

| | Bacillus | Bacillus | |
|---|---|---|---|
| | thuringiensis | thuringiensis | Relative pest |
| | activity before | activity after | control agent |
| | light exposure | light exposure | activity after |
| | (log CFU/mL) | (log CFU/mL) | light exposure |
| Example 1 | 8.76 ± 0.03 | 7.15 ± 0.10 | 3.0 times greater |
| Comparative | 8.83 ± 0.05 | 6.68 ± 0.07 | 1.0 |
| Example A | | | |

The data of Table 1 illustrates that Example 1 has an improved, i.e. 3.0 times greater, bacillus thuringiensis activity after light exposure as compared to Comparative Example A.

TABLE 2

| | Bacillus | Bacillus | |
|---|---|---|---|
| | thuringiensis | thuringiensis | Relative pest |
| | activity before | activity after | control agent |
| | light exposure | light exposure | activity after |
| | (log CFU/mL) | (log CFU/mL) | light exposure |
| Example 2 | 8.73 ± 0.06 | 7.18 ± 0.11 | 5.6 times greater |
| Comparative | 8.80 ± 0.03 | 6.43 ± 0.05 | 1.0 |
| Example B | | | |

The data of Table 2 illustrates that Example 2 has an improved, i.e. 5.6 times greater, bacillus thuringiensis activity after light exposure as compared to Comparative Example B.

TABLE 3

| | Bacillus | Bacillus | |
|---|---|---|---|
| | thuringiensis | thuringiensis | Relative pest |
| | activity before | activity after | control agent |
| | light exposure | light exposure | activity after |
| | (log CFU/mL) | (log CFU/mL) | light exposure |
| Comparative | 8.86 ± 0.01 | 6.74 ± 0.10 | 1.0 |
| Example C | | | |
| Comparative | 8.80 + 0.03 | 4.80 + 0.08 | 10 times less |
| Example D | | | |

The data of Table 3 illustrates that Comparative Example D has a decreased, i.e. 10 times less, bacillus thuringiensis activity after light exposure as compared to Comparative Example C. This decreased bacillus thuringiensis activity after light exposure further illustrates the surprising synergy of the components of the pest control compositions disclosed herein.

1. A pest control composition comprising:
humic acid;
an emulsion polymer comprising methyl methacrylate, butyl acrylate, acrylic acid and vinyl toluene;
bacillus thuringiensis; and
water.

2. The pest control composition of claim 1, wherein the humic acid is from 0.01 wt % to 5.00 wt % of the pest control composition based upon a total weight of a combination of the humic acid, the emulsion polymer, the bacillus thuringiensis, and the water.

3. The pest control composition of one of claim 1, wherein the emulsion polymer is from 0.10 wt % to 10.00 wt % of the pest control composition based upon a total weight of the combination of the humic acid, the emulsion polymer, the bacillus thuringiensis, and the water.

4. The pest control composition of any one of claim 1, wherein the emulsion polymer has 10 wt % or less acrylic acid based on the weight of the emulsion polymer.

5. The pest control composition of any one of claim 1, wherein emulsion polymer has an average particle diameter from 50 nanometers to 300 nanometers as measured using Dynamic Light Scattering.
